(19) United States
(12) Patent Application Publication
(10) Pub. No.: US 2011/0042458 A1
(43) Pub. Date: Feb. 24, 2011

(54) BEVERAGE DISPENSER, IN PARTICULAR BUT NOT EXCLUSIVELY FOR WINES

(75) Inventors: Riccardo Falci, Calenzaro (IT); Paolo Giovanni La Torre, Campi Bisenzio (IT)

Correspondence Address: LUCAS & MERCANTI, LLP, 475 PARK AVENUE SOUTH, 15TH FLOOR, NEW YORK, NY, 10016, US

(73) Assignee: DIWINE S.R.L., Palazzuolo sul Senio (FI) (IT)

(21) Appl. No.: 12/936,628

(22) PCT Filed: Mar. 23, 2009
(86) PCT No.: PCT/IB09/51202

§ 371 Date: Oct. 6, 2010

(30) Foreign Application Priority Data
Apr. 10, 2008 (IT) FI2008A000073

(51) Int. Cl. B67D 7/08; B65D 83/00; B67D 7/78; G06Q 20/00

(52) U.S. Cl. 235/381; 222/399; 222/145.1; 222/54

(57) ABSTRACT

An equipment for automatic delivery of beverages, with extraction of liquid from at least one bottle (B) in an up-right position by injection of an inert gas, the apparatus comprising a frame (1) suitable for resting on a counter or similar elevated work surface, support means of at least one bottle placed outside of the frame, gas supply means (8) for supplying an inert gas into the bottle, beverage delivery means (32-62) for delivering the liquid from the bottle (B), and programmable control means for controlling at least the inert gas supply means, characterized in that it further comprises compressed air supply means (9), adapted to feed air towards the beverage delivery means (32-62) to clean them after each delivery.

The present invention refers to the field of the automatic beverage dispensers, wherein the beverages are drawn out from bottles which are in their upright position. Such equipments are mainly used for the automatic supply of wine by the glass in wine bars, restaurants, cafes, hotel and other public places, not excluding the domestic use. These devices can be employed also with other kind of bottled beverages.

Equipments of this type are described in the published french patent application n. FR2616767 and in the european patent EP1352873. In these machines there is applied an injection of inert gas in order to extract the liquid and deliver it through a pipe which has an inlet in the neck of the bottle, ending with an outlet nozzle. This injection is achieved with an additional pipe inserted in the neck of the bottle coaxially or adjacent to the beverage delivery pipe. The two pipes are sealed with the neck of the bottle through a conical gasket system, which wraps around a sleeve within which the pipes are inserted, and against which the mouth of the bottle is forced to press on with an axial drive from the bottom.

In the equipment according to the above mentioned european patent, the inert gas is also used to clean the beverage nozzle after each delivery. In fact, it is very important, especially considering the use for the tasting of high quality wines, that the spout be immediately released from residues that, if left to dry, can contaminate the subsequent delivery.

The inert gas, typically nitrogen, is supplied from a gas cylinder arranged outside the body of the equipment that is rested on a counter or on any other type of support inside the bar or the like. The total dimensions, intrinsic and resulting from the positioning of the external cylinder, is a major problem that can restrict the potential use of the equipment.

Besides that, this kind of gas feed creates installation and maintenance problems, since the equipment, in its daily use, is handled by restaurant staff, who have little or no technical preparation.

The object of the present invention is therefore to overcome these drawbacks by providing an equipment for the automatic delivery of bottled beverages in upright position which is more compact and easier to install compared with the machines cited before.

This and other objects are achieved with the beverage dispenser, in particular but not exclusively for wines, according to the invention, whose essential features are defined by the first of the attached claims.

The characteristics and advantages of the beverage dispenser, in particular but not exclusively for wines, according to the invention shall be apparent from the following description of an embodiment thereof, provided for exemplifying and non-limiting purposes with reference to the attached drawings, wherein:

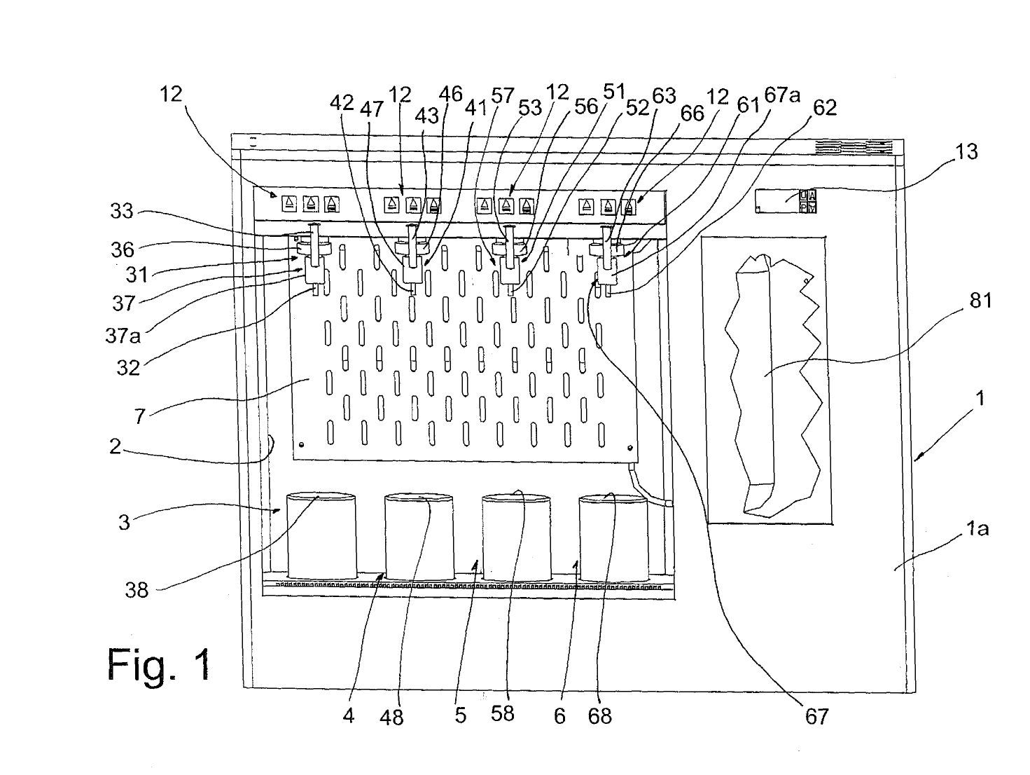

FIG. 1 is a front view of the equipment according to the invention, partially broken; and

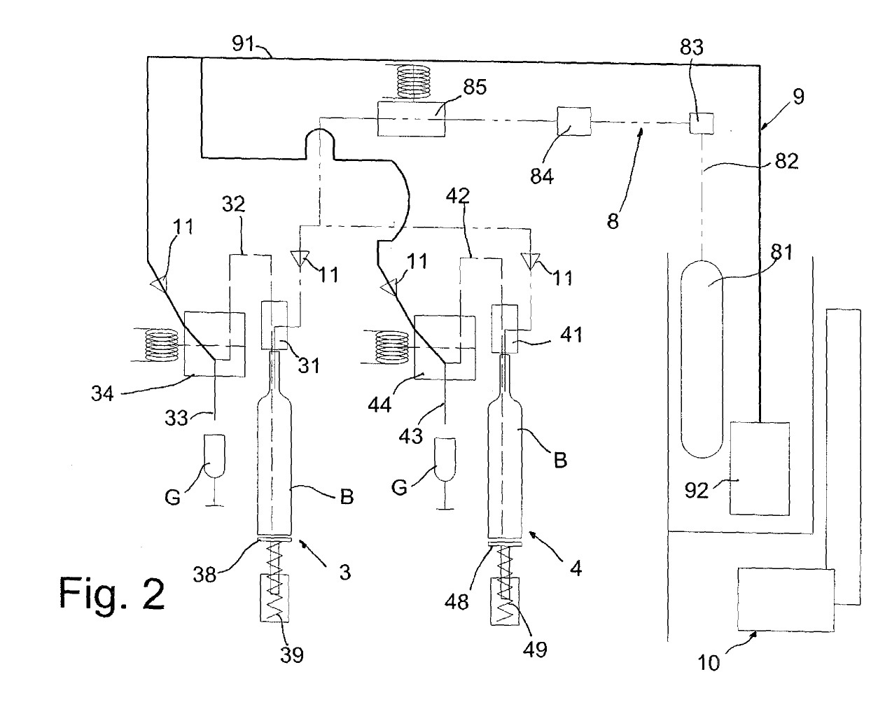

FIG. 2 is a schematical structural diagram of the device of FIG. 1, in which the circuits of liquid, inert gas and air are shown.

Referring to the above figures, the equipment according to the invention comprises a box-like frame 1, parallelepiped-shaped, suitable to be rested on a counter or on any other type of support of a bar, restaurant or the like in a higher position compared with the ground. A large recess 2 is formed in a front face 1a of the frame 1. Inside the recess 2 a plurality of bottles B, from which the liquid must be drawn out for delivery, are arranged. With reference to the example, the recess 2 permits to house up to four bottles placed side by side in upright position. The bottles B are not shown in FIG. 1, but it is possible to see the four respective places, which are marked with a numerical reference from 3 to 6 and that will be discussed below.

The vertical back wall of the recess 2, in the illustrated embodiment, is extensively defined by a perforated panel 7, through which an optional air conditioning system, of a traditional type, placed inside the frame 1 and indicated at 10 in the diagram of FIG. 2, realizes an effect of thermal control of the liquid in the bottles. The air conditioning system, if provided, can be simply refrigerant (for white wines), or refrigerant and heating (for red wines), and potentially also differentiated by bottle place to bottle place. Adjacent to the recess 2, on the right in accordance with the view of FIG. 1, the frame also houses a circuit 8 for the supply of inert gas, for example nitrogen, represented in FIG. 2 with a dash line with double point.

The gas supply circuit 8 comprises a replaceable storage cylinder 81, housed inside the frame 1, as specified further below, which feeds gas through a line 82, with in sequence a tap 83, a pressure reducer 84, and an electrovalve 85, towards respective insufflation sleeves 31, 41, 51, 61 each belonging to a place of arrangement of a bottle. The line 82, in fact, is splitted after the electrovalve into a plurality of branches, each connected to a sleeve, two of which are shown in the diagram of FIG. 2.

Each of these sleeves 31-61, projecting downwards from the top of the recess 2 and engaged with the bottle neck of a respective bottle, houses a first end of a beverage delivery pipe 32-62 (one for each bottle, represented with a dashed line in FIG. 2 only for the two places 3 and 4). The other end, that is the output of the beverage towards a glass G, is defined by a delivery nozzle 33-63, in turn projecting from the top of the recess 2. The first, input end of the delivery pipe, that is the one inside the sleeve, is shown in FIG. 2, being placed coaxially with the center of the gas injection spout. The beverage delivery nozzle 33-63 is placed downstream of a delivery electrovalve 34-64, to which a branch of a pneumatic circuit 9 (represented with a bold line in FIG. 2) is also connected. This pneumatic circuit 9, through a line 91 divided in several branches to the respective bottle places, is used to inject compressed air, generated by a compressor 92 arranged in the same frame 1, in the nozzle 33-63, in order to clean it after each beverage delivery.

Several non-return valves 11 are arranged in suitable locations (FIG. 2) in the relative circuits, as obvious on the basis of the known technique. Equally obvious is the configuration of the power supply system (with connection to the mains), and of the control system of the equipment. This allows an automatic control, based on programmed instructions, commanding the electrovalves further to the activation, by the user, of keys 12 arranged above the recess 2. In particular, in the example, a group of three keys for the delivery of three different quantities gradually increasing (25 cc, 50 cc, 100 cc) is provided for each bottle place 3-6. Obviously, different quantities can be programmed according to the requirements, even with a different number of keys.

A possible further command, not shown, as well as the electrical master switch, is used for setting the temperature controlled from the air conditioning system, displayed via a display 13 and controlled by an appropriate thermostat. Furthermore, the control system can include, fully according to the traditional solutions and neither represented in the figures nor described in details, means for charging the delivered drinks, typically through the progressive deduction of credit accumulated on a prepaid card, magnetic or on a microchip, to be passed through a reading/recording device. Obviously, the amount of credit to be charged for each delivery will be programmable especially in relation to the value of the delivered beverage.

Returning to the configuration of each bottle place, the support of each single bottle is provided directly by the respective sleeves 31-61. More precisely, a sleeve comprises a cylindrical body 37-67 in which, as anticipated above, openings for the passage of the gas and the beverage are formed, and to the outer surface of which is associated a radial expansion gasket 37a-67a. The expansion of the gasket causes the locking with the inner surface of the neck of the bottle, which provides the necessary seal of the bottle and at the same time, through friction, sustains it. This expansion is driven by respective threaded ring nuts 36-66 arranged coaxially to said cylindrical sleeves and upstreams thereof. The ring nuts can be operated in order to press axially on the gaskets and cause their expansion. Without real support functions, but rather with aesthetic purposes, basement plates 38-68 can also be provided at each bottle place, projecting from the base wall of the recess 2 and adapted to press on the bottom of the bottle (through springs 39-69) with a weak elastic contrast.

From what has been explained above, it is clear that the equipment according to the invention has the characterizing feature to realize the cleaning of the delivery nozzles through a pneumatic circuit with a compressor inside the frame. From this, that is, the fact that the feeding system of the inert gas is no more used for the expensive (in terms of gas consumption) cleaning function, it follows the great advantage of being able to use a gas cylinder of a capacity significantly smaller (typically about one liter at 100 bar pressure) than the known equipment. Consequently, the cylinder can be placed directly within the frame and no more in a remote position.

Therefore, the equipment according to the invention involves drastically simplified transportation and installation ways, which can be easily managed even by non specialized staff, the installation consisting of resting on a counter or any other work surface of an appropriate height. Equally easy is the maintenance, which requires only the replacement of the cylinder when it is empty. The equipment is compact and space-saving and therefore more widely usable.

The machine, thus conceived, can be liable of many modifications and variations, all referred to the invention; besides, all the details can be substituted with other elements technically equivalent, without thereby departing from the scope of protection of the invention.

In practice, the materials used, if compatible with the specific use, as well as the size, can be of any type according to requirements and the state of the art.

Where the characteristics and techniques mentioned in any claim are followed by reference signs, these were attached, as an example, for the sole purpose of increasing the intelligibility of the claims and thus do not have any limiting effect on the interpretation of each element they identify.

1. A device for automatic delivery of beverages, with extraction of liquid from at least one bottle in an upright position by injection of an inert gas, the apparatus comprising;
a frame suitable for resting on a counter or similar elevated work surface;
support means of said at least one bottle;
gas supply means for supplying an inert gas into said bottle;
beverage delivery means for delivering said liquid from said bottle, and
programmable control means for controlling at least said gas supply means, wherein said gas supply means comprises compressed air supply means, adapted to feed air towards said beverage delivery means.

2. The device of claim 1, wherein said beverage delivery means comprises
a circuit having an inlet in the neck of said bottle;
a delivery nozzle for delivering the liquid inside a glass; and
compressed air supply means, wherein said compressed air supply means communicates with said delivery nozzle.

3. The device of claim 1, wherein said inert gas supply means comprises a replaceable storage cylinder of said gas, contained within said frame.

4. The device of claim 3, wherein said cylinder has a capacity of about 1 liter at 100 bar pressure.

5. The device of claim 1, wherein said support means comprise, for each bottle,
a cylindrical body adapted to be inserted coaxially inside the neck of the bottle,
radial expansion sealing means provided in said body to be engaged with the inner surface of the neck of the bottle, and
threaded ring nut means arranged coaxially to said body, adapted to be operated to induce the expansion of said sealing means,
wherein inside said body there is formed, with an axial extension, pipes for the supply of inert gas and the delivery of liquid from the bottle, said pipes belonging respectively to said inert gas supply means and said beverage delivery means

6. The to device of claim 5, further comprising basement members one for each bottle, without support function, adapted to abut on the bottom of the bottle with a weak elastic contrast.

7. The device of claim 1, wherein said frame comprises
a recess for the arrangement of a plurality of bottles placed side by side, each bottle having independent support means,
said control means are adapted for controlling independently said inert gas supply means and said compressed air feeding means for each bottle.

8. The device of claim 1, wherein said frame comprises air conditioning means for controlling and regulating the temperature of said beverage in said at least one bottle.

9. The device of claim 2, wherein said compressed air supply means comprises a line divided into a plurality of branches to respective nozzles and to a compressor arranged in said frame.

10. The device of claim 1, wherein said control means provide for the progressive deduction of credit accumulated on a prepaid, magnetic or microchip card, to be passed through a reading/recording device.
